(19) United States
(12) Patent Application Publication
(10) Pub. No.: US 2009/0303975 A1
(43) Pub. Date: Dec. 10, 2009

(54) METHOD AND SYSTEM FOR WIRELESS COEXISTENCE

(75) Inventors: Ariton E. Xhafa, Plano, TX (US); Jin-Meng Ho, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/436,229

(22) Filed: May 6, 2009

Related U.S. Application Data
(60) Provisional application No. 61/059,094, filed on Jun. 5, 2008.

(51) Int. Cl. H04W 88/04

(52) U.S. Cl. 370/338

(57) ABSTRACT

A system and method for reducing wireless local area network (WLAN) interference with a different wireless network (non-WLAN). A wireless device includes a WLAN transceiver and a non-WLAN transceiver. The WLAN transceiver is configured to operate in a WLAN, and configured to operate selectively using one of a greater bandwidth and a lesser bandwidth in a frequency band. The wireless communication of the non-WLAN is incompatible with the WLAN. The non-WLAN transceiver is configured to request the WLAN transceiver operate using the lesser bandwidth.

The present application claims priority to and incorporates by reference provisional patent application 61/059,094, filed on Jun. 5, 2008, entitled “Method and Systems to Support Wireless Coexistence.”

### BACKGROUND

The wireless space is crowded with a variety of networks based on different technologies. Among them are IEEE 802.16 (WiMax) networks, IEEE 802.11 wireless local area networks (WLAN), long-term evolution (LTE) networks, Wireless Universal Serial Bus (USB) networks, Bluetooth networks, and body area networks. These networks operate in overlapping or adjacent frequency bands. The simultaneous operation of these networks in overlapping areas can cause detrimental mutual interference.

Wireless technology coexistence issues may be further exacerbated by the doubling of IEEE 802.11n WLAN operational bandwidth from 20 MHz to 40 MHz in the lower portion of the Industrial, Scientific, and Medical (ISM) band. This doubling of WLAN bandwidth will significantly increase interference with non-WLAN networks occupying narrower bandwidths, such as Bluetooth and WiMax.

The IEEE 802.11n standard has introduced a 40 MHz Intolerant bit contained in a management frame (i.e. a beacon) to allow devices to indicate their intolerance to the use of 40 MHz bandwidth. However, the Intolerant bit is ineffective with regard to protecting non-WLAN devices because Bluetooth and devices based on other non-WLAN technologies cannot transmit IEEE 802.11 compliant beacons.

### SUMMARY

Various systems and methods for reducing wireless local area network (WLAN) interference with other another wireless network (non-WLAN). In some embodiments, a wireless device includes a WLAN transceiver and a non-WLAN transceiver. The WLAN transceiver is configured to operate in a WLAN, and configured to operate selectively using one of a greater bandwidth and a lesser bandwidth in a frequency band. The wireless communication of the non-WLAN is incompatible with the WLAN. The non-WLAN transceiver is configured to request the WLAN transceiver operate using the lesser bandwidth.

In accordance with at least some other embodiments, a method includes asserting, in a wireless device, a signal that notifies a WLAN transceiver in the device that a non-WLAN transceiver co-located in the device requests that the WLAN transceiver operate using a lower of two different bandwidths at which the WLAN transceiver is capable of operating. The non-WLAN wireless communication is incompatible with the WLAN transceiver. Based on the signal, the WLAN transceiver is configured to operate using the lower of two different bandwidths.

In accordance with yet other embodiments, a wireless system includes a plurality of WLAN transceivers, a plurality of non-WLAN transceivers, and a first wireless device. The plurality of WLAN transceivers is configured to operate in a WLAN, and configured to operate selectively using one of a greater bandwidth and a lesser bandwidth. The wireless communication of the plurality of non-WLAN transceivers is incompatible with the WLAN. The first wireless device includes one of the plurality of WLAN transceivers and one of the plurality of non-WLAN transceivers. The non-WLAN transceiver in the first wireless device is configured to communicate with the WLAN transceiver in the first wireless device, and to request the WLAN transceiver in the first wireless device operate using the lesser bandwidth.

### BRIEF DESCRIPTION OF THE DRAWINGS

For a detailed description of exemplary embodiments of the invention, reference will now be made to the accompanying drawings in which:

FIG. 1 shows an exemplary wireless environment that includes a wireless local area network (WLAN) and a wireless network that is incompatible with the WLAN (non-WLAN) in accordance with various embodiments;

FIG. 2 shows an exemplary block diagram of a wireless device that includes a WLAN)transceiver and a non-WLAN transceiver in accordance with various embodiments;

FIG. 3 shows a flow diagram for a method for operating a non-WLAN transceiver to reduce WLAN interference with the non-WLAN transceiver in accordance with various embodiments; and

FIG. 4 shows a flow diagram for a method for operating a WLAN transceiver to reduce WLAN interference with non-WLAN transceivers in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein are a system and method for reducing wireless local area network (WLAN) interference with another wireless networking (non-WLAN) system. More specifically, the systems ands methods of the present disclosure operate to reduce IEEE 802.11n interference with other non-IEEE 802.11 wireless systems that operate in frequency bands that overlap or are adjacent to the 2.4-2.483 gigahertz portion of the Industrial, Scientific, and Medical (ISM) band. IEEE 802.11n devices may use a bandwidth of either 20 megahertz (MHz) or 40 MHz. Use of the 40 MHz bandwidth significantly increases WLAN interference with non-WLAN devices operating in an adjacent or overlapping frequency band. Inclusion of a 40 MHz Intolerant bit in a WLAN transmission, in accordance with the IEEE 802.11n standard, fails to reduce WLAN interference with non-WLAN devices because non-WLAN devices use different communication technologies as defined by a combination of modulation and coding schemes, frame formats, etc. Consequently, devices of non-WLAN networks, e.g., Bluetooth, IEEE 802.16 (WiMax), long-term evolution (LTE), etc., are unable to indicate intolerance to the use of 40 MHz bandwidth by WLAN devices. Embodiments of the present disclosure allow a non-WLAN device to communicate its intolerance for WLAN 40 MHz bandwidth operation to a WLAN device.

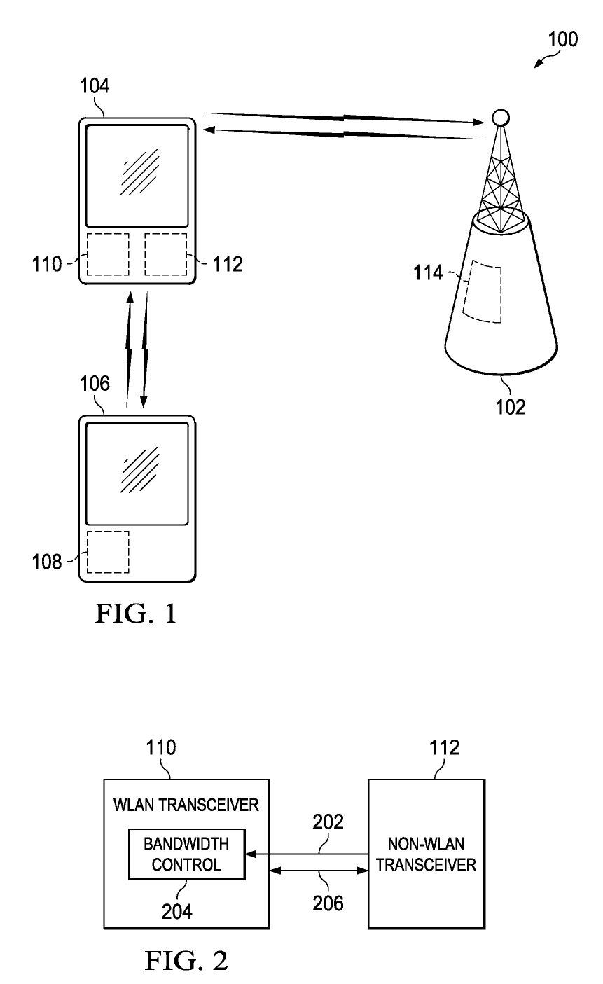

FIG. 1 shows an exemplary wireless environment 100 that includes a WLAN and a non-WLAN wireless network that is incompatible with the WLAN in accordance with various embodiments. The WLAN includes an access point 102, and a mobile wireless device 104. In practice, a WLAN may include one or more mobile wireless devices. The mobile wireless device 104 transmits data to and receives data from the access point 102. The access point 102 can also be referred to as a base station, a node B, etc. Some embodiments of the WLAN can employ ad-hoc networking, and may not include the access point 102. Instead, the mobile wireless device 104 can communicate directly with another mobile WLAN device. Exemplary mobile WLAN devices include cellular telephones, personal digital assistants, personal computers, navigation devices, personal music players, video gaming systems, etc. The WLAN can be an IEEE 802.11n compliant network capable of using either a 20 MHz bandwidth or a 40 MHz bandwidth.

A second wireless network that includes the wireless devices 104 and 106 is also operating in the wireless environment 100. The second network is incompatible with the WLAN in that the wireless technologies and/or protocols used by the second network do not allow for wireless communications with the WLAN. The wireless technology used by the second network can be, for example, Bluetooth, ZigBee, WiMax, LTE, etc. Exemplary devices used in the wireless network include cellular telephones, personal digital assistants, personal computers, navigation devices, personal music players, video gaming systems, etc. The frequency bands used by the second network can be adjacent to or overlap the frequency bands used by the WLAN. Consequently, operation of the WLAN can interfere with operation of the second network by directly interfering with transmissions in overlapping bands or by out-of-band emissions that saturate receivers or interfere with transmissions in adjacent frequency bands.

The mobile wireless devices 104 and 106 are shown operating in the second network. In practice, the second network may include any number of mobile wireless devices. The mobile wireless device 104 includes a WLAN transceiver 110 for transmitting and receiving wireless signals on the WLAN. The mobile wireless device 104 also includes a non-WLAN transceiver 112 for transmitting and receiving wireless signals on the second wireless network. Thus, the wireless device 104 includes co-located WLAN and non-WLAN transceivers. The wireless device 106 is not configured to operate on the WLAN and includes only a non-WLAN transceiver 108.

In order to reduce WLAN interference with the operation of the second network, wireless transceivers 108, 112 configured to use the second network, preferably communicate their intolerance for use of a wider (e.g. a 40 MHz) bandwidth by the WLAN transceivers. Unfortunately, as explained above, the non-WLAN transceivers 108, 112 are incapable of wirelessly communication with the WLAN transceivers.

Embodiments of the present disclosure provide a communication channel between a WLAN transceiver 110 and a non-WLAN transceiver 112 co-located in wireless device 104. When the non-WLAN transceiver 112 needs to prevent a WLAN transceiver from using, for example, a 40 MHz bandwidth, the non-WLAN transceiver 112 signals the co-located WLAN transceiver 110 through a communication channel internal to the wireless device 104. The signal indicates a request for the WLAN to use a lesser rather than a greater bandwidth (e.g., to use 20 MHz rather than 40 MHz of bandwidth). The WLAN transceiver 110 can then wirelessly communicate the lower bandwidth request to other WLAN transceivers in the WLAN (e.g., to WLAN transceiver 114 in the access point 102). For example, in an IEEE 802.11n network the WLAN transceiver 110 can transmit the 40 MHz Intolerant bit to other WLAN transceivers. The Intolerant bit instructs WLAN transceivers not use a 40 MHz bandwidth.

The non-WLAN transceiver 112 can wirelessly transmit a message to other non-WLAN transceivers (e.g., transceiver 108) indicating that the non-WLAN transceiver 112 is co-located with and configured to communicate with the WLAN transceiver 110. The message informs the non-WLAN transceiver 108 that the non-WLAN transceiver 112 is capable of acting as a proxy to communicate the necessary co-existence message (i.e., high bandwidth intolerance) to the WLAN transceivers 110, 114.

The non-WLAN transceiver 112 can receive a message from the non-WLAN transceiver 108, via wireless transmission, requesting that the WLAN transceivers 110, 114 not use a high bandwidth. When the non-WLAN transceiver 112 receives such message, the non-WLAN transceiver 112 signals the co-located WLAN transceiver 110 to request the bandwidth restriction as explained supra. If the non-WLAN transceiver 112 is inactive, for example, in a low power mode or sleep mode in which wireless non-WLAN transmissions are not received, the non-WLAN transceiver 112 can be periodically or intermittently activated to receive a bandwidth restriction message and to signal the WLAN transceiver 110.

When the non-WLAN transceiver 108 desires to prevent the WLAN transceivers 110, 114 from using a high bandwidth, the non-WLAN transceiver 108 can wirelessly transmit a message to other non-WLAN transceivers. The message contains the bandwidth restriction request. The non-WLAN transceiver 108 can broadcast the message if it knows of no non-WLAN transceiver 112 co-located with a WLAN transceiver 110, and can unicast the message if a non-WLAN transceiver 112 is known to be co-located with a WLAN transceiver 110. In any embodiment, a non-WLAN transceiver 112 that receives the message and is co-located with a WLAN transceiver 110 signals the WLAN transceiver with regard to the bandwidth restriction request as described above.

In some embodiments, if a WLAN transceiver 110 has received a bandwidth restriction request via either an in device signal from a non-WLAN transceiver 112, or a wireless transmission from a different WLAN transceiver, the WLAN transceiver 110, if inactive (e.g., in a low-power state where WLAN transmissions are not received) can be periodically or intermittently activated to detect WLAN operation using the higher bandwidth. If the WLAN transceiver 110 does detect WLAN operation using the higher bandwidth, the WLAN transceiver 110 can transmit the bandwidth restriction request to the other WLAN transceivers 114 in the WLAN.

FIG. 2 shows an exemplary block diagram of a wireless device 104 that includes a WLAN transceiver 110 and a non-WLAN transceiver 112 in accordance with various embodiments. The WLAN transceiver 110 and the non-WLAN transceiver 112 operate in adjacent or overlapping frequency bands, and are incapable of wirelessly communicating with one another. The WLAN transceiver 110 can operate using either a first bandwidth or a second bandwidth, where one of the first and second bandwidths is a greater bandwidth and one is a lesser bandwidth. For example, the first bandwidth may be 40 MHz and the second bandwidth 20 MHz. Operation using the greater bandwidth is advantageous in that the rate of data transfer is increased. However, using the greater bandwidth also significantly increases interference with operation of the non-WLAN transceiver 112.

The WLAN transceiver 110 includes a bandwidth control module 204 that determines whether the WLAN transceiver 110 operates using the greater or the lesser bandwidth. In an IEEE 802.11n WLAN, the bandwidth control module 204 may determine whether the WLAN transceiver 110 operates using a 40 MHz or a 20 MHz bandwidth.

The WLAN transceiver 110 and the non-WLAN transceiver 112 can also include a variety of components that are not shown, for example, amplifiers, filters analog-to-digital converters, digital-to-analog converters, modulators, demodulators, encoders, decoders, etc.

The non-WLAN transceiver 112 asserts a signal 202 to request that the WLAN transceiver operate using the lesser rather than the greater bandwidth. The signal 202 provides for communication between the non-WLAN transceiver 112 and the WLAN transceiver 110. When the bandwidth control module 204 detects assertion of the signal 202, the bandwidth control module 204 can configure the WLAN transceiver 110 for operation using the lesser bandwidth. Additionally, the WLAN transceiver 110 can wirelessly communicate the bandwidth restriction request to other WLAN transceivers operating in a wireless network.

To accommodate non-WLAN transceivers that are not co-located with a WLAN transceiver, embodiments of the non-WLAN transceiver 112 can receive messages transmitted by other non-WLAN transceivers requesting a WLAN bandwidth restriction and assert the signal 202. Thus, embodiments of the present disclosure allow a non-WLAN wireless transceiver 108 to communicate its intolerance for use of the greater bandwidth by the WLAN transceiver 110.

In at least some embodiments of the WLAN transceiver 110 and the non-WLAN transceiver 112, the signals 206 provide information used to control the activation and deactivation of the transceivers 110, 112. For example, in some embodiments the WLAN transceiver 110 or the non-WLAN transceiver 112 may be intermittently activated to determine whether any action should be taken to reduce the bandwidth used by the WLAN. Information exchanged between the transceivers 110, 112 can be used to determine when and how long the transceivers are activated.

If the non-WLAN transceiver 112 is intermittently/periodically activated to receive a request for WLAN bandwidth restriction, information provided by the WLAN transceiver 110 via signals 206 (e.g., information regarding whether the WLAN may operate using a higher bandwidth) can be used to determine the non-WLAN transceiver 112 activation and/or deactivation intervals. Similarly, control provided via the signals 206 can allow the WLAN transceiver 112 to activate the non-WLAN transceiver 110 to notify the non-WLAN transceiver 112 of a change in WLAN state. For example, the WLAN transceiver 110 can activate the non-WLAN transceiver 110 if the WLAN transitions from lower to higher bandwidth operation.

The non-WLAN transceiver 112 may also provide information and/or control to the WLAN transceiver 110 via the signals 206. For example, the non-WLAN transceiver 112 can activate the WLAN transceiver 110 via the signals 206 if the non-WLAN transceiver 112 detects other non-WLAN devices in its wireless network.

Various components of the WLAN transceivers 110, 114 and the non-WLAN transceivers 108, 112, including at least some portions of the bandwidth control module 204, can be implemented using a processor and software programming that causes the processor to perform the operations described herein. In particular, software programming can cause a processor to provide the bandwidth restriction signal 202, to configure the WLAN transceiver 110 for lesser bandwidth operation, to configure the WLAN transceiver 110 to transmit the bandwidth restriction request to other WLAN transceivers 114, to transmit and/or receive a non-WLAN bandwidth restriction request, etc. as described herein. Suitable processors include, for example, general-purpose processors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming can be stored in a computer readable medium. Exemplary computer readable media include semiconductor memory, optical storage, and magnetic storage.

Some embodiments can implement the functionality described herein using dedicated circuitry. Some embodiments may use a combination of dedicated circuitry and software executed on a processor. Selection of a hardware or software implementation of embodiments is a design choice based on a variety of factors, such as cost and the ability to incorporate changed or additional functionality in the future.

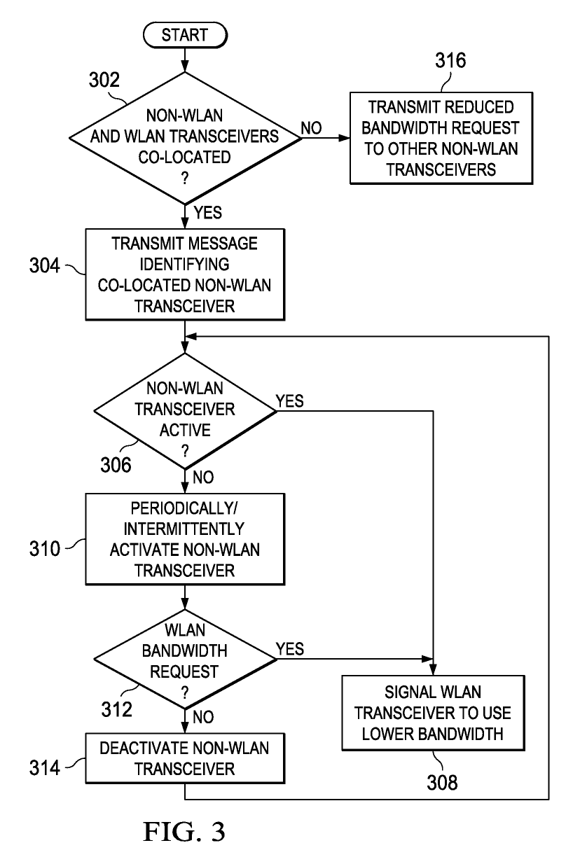

FIG. 3 shows a flow diagram for a method for operating a non-WLAN transceiver 112, 108 to reduce WLAN interference with the non-WLAN transceiver 112, 108 in accordance with various embodiments. Though depicted sequentially as a matter of convenience, at least some of the actions shown can be performed in a different order and/or performed in parallel. Additionally, some embodiments may perform only some of the actions shown. In some embodiments, the operations of FIG. 3, as well as other operations described herein, can be implemented as instructions stored in a computer readable medium and executed by a processor.

In block 302, a non-WLAN transceiver 112, 108 determines whether a WLAN transceiver 110 is co-located in the wireless device 104, 106 with the non-WLAN transceiver 112, 108. In a wireless device 106, in which a WLAN transceiver 110 is not co-located with the non-WLAN transceiver 108, in block 316, the non-WLAN transceiver 108 wirelessly transmits a message to other non-WLAN transceivers (e.g., transceiver 112) operating in the non-WLAN network indicating that WLAN transceivers 110, 114 operating in the area should reduce interference with the non-WLAN transceivers 108, 112. The WLAN transceivers 110, 114 can reduce interference with the non-WLAN transceivers 112, 108 by using lower bandwidth operation. For example, an IEEE 802.11n WLAN transceiver can operate with a 20 MHz bandwidth rather than a 40 MHz bandwidth. If, in block 316, the non-WLAN transceiver 108 is aware of a different non-WLAN transceiver 112 that is co-located with a WLAN transceiver 110, the non-WLAN transceiver 108 may unicast the message to the different non-WLAN transceiver 112, otherwise the non-WLAN transceiver 108 can broadcast the message.

If, in block 302, the non-WLAN transceiver 112 determines that a WLAN transceiver 110 is co-located in a wireless device 104 with the non-WLAN transceiver 112, then, in block 304, the non-WLAN transceiver 112 transmits a message to other non-WLAN transceivers. The message indicates that the non-WLAN transceiver is co-located with a WLAN transceiver 110, and is configured to signal the WLAN transceiver 110 with a bandwidth restriction request.

If the non-WLAN transceiver 112 is active (e.g., in use), as determined in block 306, then, in block 308, the non-WLAN transceiver 112 asserts a signal 202 to the co-located WLAN transceiver 110. The signal 202 indicates a request for the WLAN transceiver 110 (and all other WLAN transceivers in the area (e.g., transceiver 114)) to operate using the lower bandwidth of at least two bandwidths at which the WLAN transceiver 110 can operate.

If, the non-WLAN transceiver 112 is inactive (e.g., in a low power state where non-WLAN wireless transmissions are not detected), as determined in block 306, then, in block 310, the non-WLAN transceiver 112 may be periodically or intermittently activated, for an activation time interval, to receive wireless transmissions. Activation may scheduled for a predetermined time, or controlled by the WLAN transceiver. If while active, in block 312, the non-WLAN transceiver 112 determines that WLAN bandwidth should be restricted, for example, if the non-WLAN transceiver 112 receives a request from a different non-WLAN transceiver 108 to restrict WLAN bandwidth, then the co-located WLAN transceiver 110 is signaled, in block 308, as described above. If while active, in block 312, the non-WLAN transceiver 112 does not receive a request from a different non-WLAN transceiver 108 to restrict WLAN bandwidth, then the non-WLAN transceiver 112 is deactivated in block 314, for a deactivation time interval.

In some embodiments, the activation and/or deactivation time intervals can be set in accordance with an expectation of receiving a bandwidth restriction message. For example, in a crowded wireless environment where the non-WLAN transceiver 112 is aware of other non-WLAN transceivers (e.g., transceiver 108) with which the co-located WLAN transceiver 110 may conflict, the deactivation interval may be shortened and/or the activation interval may be lengthened. In other environments, or to reduce power consumption, the deactivation interval may be lengthened and/or the activation interval may be shortened.

In some embodiments, the activation and/or deactivation intervals can be adaptive and/or other information can be used to determine when the non-WLAN transceiver 112 is activated or deactivated. Embodiments of the non-WLAN transceiver 112 may use information provided by the WLAN transceiver 110 to determine when the non-WLAN transceiver 112 is activated or deactivated. For example, if the WLAN transceiver 110 provides information indicating that the WLAN is using a lower bandwidth, then the non-WLAN transceiver 112 deactivation interval may be extended, or intermittent activation may be suspended.

The WLAN transceiver 110 may also provide control for the non-WLAN transceiver 112. If the non-WLAN transceiver 112 is inactive, the WLAN transceiver 110 can cause the non-WLAN transceiver 112 to activate. The decision to activate the non-WLAN transceiver 112 may be based on, for example, the bandwidth used in the WLAN in which the WLAN transceiver 110 operates. For example, if the WLAN transceiver 110 detects a WLAN transition from lower to higher bandwidth use, then the WLAN transceiver 110 may activate the non-WLAN transceiver 112 to notify the transceiver 112 of the state of the WLAN. In at least some embodiments, when the non-WLAN transceiver 112 has previously requested that the WLAN use a lower bandwidth, by for example assertion of the signal 202, the non-WLAN transceiver 112 deactivation interval may be lengthened.

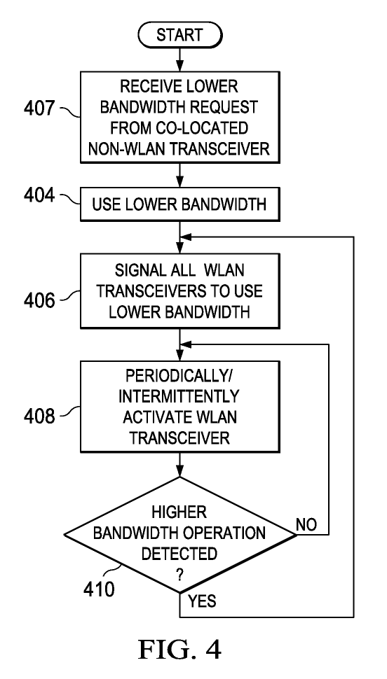

FIG. 4 shows a flow diagram for a method for operating a WLAN transceiver 110 to reduce WLAN interference with non-WLAN transceivers 108, 112 in accordance with various embodiments. Though depicted sequentially as a matter of convenience, at least some of the actions shown can be performed in a different order and/or performed in parallel. Additionally, some embodiments may perform only some of the actions shown. In some embodiments, the operations of FIG. 4, as well as other operations described herein, can be implemented as instructions stored in a computer readable medium and executed by a processor.

In block 402, a non-WLAN transceiver 112 co-located in a wireless device 104 with the WLAN transceiver 110 asserts a signal 202 to the WLAN transceiver 110. The signal 202 indicates a request for the WLAN transceiver 110 to operate using a lower bandwidth where the WLAN transceiver 110 is capable of operating with a lower bandwidth and a higher bandwidth.

In block 404, the WLAN transceiver 110 responds to the received request by using the lower bandwidth rather than the higher bandwidth. The WLAN transceiver 110 preferably wirelessly transmits an indication of the bandwidth restriction request to all other WLAN transceivers (e.g., transceiver 114) in the WLAN in block 406, causing all receiving WLAN transceivers to operate at the lower bandwidth.

In block 408, if the WLAN transceiver 110 is inactive (e.g., in a low power mode where wireless transmissions are not detected), then the WLAN transceiver 110 can be periodically or intermittently activated (e.g., on expiration of a deactivation time interval or based on control provided by the non-WLAN transceiver 112) to determine whether a WLAN transceiver 114 in the WLAN is operating at the higher bandwidth. If while active for an activation time interval, in block 410, the WLAN transceiver 110 detects a WLAN transmission at the higher bandwidth, the WLAN transceiver 110 transmits the bandwidth restriction request in block 406, as described above. If, during the activation time interval, the WLAN transceiver 110 does not detect a WLAN transmission at the higher bandwidth, the WLAN transceiver 110 can be deactivated for a deactivation time interval. The activation and deactivation time intervals applied to the WLAN transceiver 110 may be different from the activation and deactivation time intervals applied to the non-WLAN transceiver 112.

In some embodiments, WLAN transceiver 110 deactivation interval may be lengthened or intermittent activation suspended if the WLAN transceiver 110 has information indicating that the WLAN will not use a higher bandwidth. Additionally, the non-WLAN transceiver 112 can be capable of activating the WLAN transceiver 110. The non-WLAN transceiver 112 may activate the WLAN transceiver 110 if, for example, the non-WLAN transceiver 112 has detected another non-WLAN device in its wireless network.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless device, comprising:
a wireless local area network (WLAN) transceiver configured to operate in a WLAN, and configured to operate selectively using one of a greater bandwidth and a lesser bandwidth in a frequency band;
a wireless network transceiver (non-WLAN transceiver) whose wireless communication is incompatible with the WLAN;
wherein the non-WLAN transceiver is configured to request the WLAN transceiver operate using the lesser bandwidth.

2. The wireless device of claim 1, wherein the WLAN transmitter receives a request from the non-WLAN transceiver to operate using the lesser bandwidth and notifies other WLAN transmitters in a wireless system of the request.

3. The wireless device of claim 1, wherein the non-WLAN transceiver receives a message from a different non-WLAN transceiver requesting that the WLAN transceiver operate using the lesser bandwidth, and the non-WLAN transceiver requests that the WLAN transceiver operate using the lesser bandwidth based on the message.

4. The wireless device of claim 1, wherein the non-WLAN transceiver intermittently exits a low power mode to listen for a message requesting that the WLAN transceiver operate using the lesser bandwidth, the message is transmitted by a different non-WLAN transceiver.

5. The wireless device of claim 1, wherein the non-WLAN transceiver transmits a message indicating that the non-WLAN transceiver is co-located in the wireless device with the WLAN transceiver, and indicating that the non-WLAN transceiver is configured to request that the WLAN transceiver operate using the lesser bandwidth.

6. The wireless device of claim 1, wherein the WLAN transceiver intermittently exits a low power state to detect operation of a different WLAN transceiver using the greater bandwidth, and if operation of a different WLAN transceiver using the greater bandwidth is detected, the WLAN transceiver notifies other WLAN transmitters in a wireless system of a request to operate using the lesser bandwidth.

7. The wireless device of claim 1, wherein the WLAN transceiver is an IEEE 802.11n transceiver, the greater bandwidth is 40 megahertz, and the lesser bandwidth is 20 megahertz.

8. A method, comprising:
asserting, in a wireless device, a signal that notifies a wireless local area network (WLAN) transceiver in the device that a wireless network (non-WLAN) transceiver co-located in the device requests that the WLAN transceiver operate using a lower of at least two different bandwidths at which the WLAN transceiver is capable of operating, the non-WLAN wireless communication is incompatible with the WLAN transceiver; and
configuring the WLAN transceiver to operate using the lower of the at least two different bandwidths based on the signal.

9. The method of claim 8, further comprising wirelessly transmitting a notification of the request to operate using the lower bandwidth from the WLAN transceiver to a different WLAN transceiver.

10. The method of claim 8, further comprising receiving in the non-WLAN transceiver a wireless transmission from a different non-WLAN transceiver, the wireless transmission includes a request that the WLAN transceiver operate using the lower bandwidth, the non-WLAN transceiver asserts the signal based on the received wireless transmission.

11. The method of claim 8, further comprising transitioning the non-WLAN transceiver from an inactive state to an active state on an intermittent basis, in the active state the non-WLAN transceiver listens for a wireless transmission from a different non-WLAN transceiver, the wireless transmission includes a request that the WLAN transceiver operate using the lower bandwidth.

12. The method of claim 8, further comprising transmitting a message from the non-WLAN transceiver to a different non-WLAN transceiver, the message indicates that the non-WLAN transceiver is co-located in the wireless device with the WLAN transceiver, and indicates that the non-WLAN transceiver is configured to request that the WLAN transceiver operate using the lower bandwidth.

13. The method of claim 8, further comprising transitioning the WLAN transceiver from an inactive state to an active state on an intermittent basis, in the active state the WLAN transceiver detects operation of a different WLAN transceiver at other than the lower bandwidth, the WLAN transceiver notifies other WLAN transmitters in a WLAN of a request to operate using the lower bandwidth.

14. A wireless system, comprising:
a plurality of wireless local area network (WLAN) transceivers configured to operate in a WLAN, the WLAN transceivers are configured to operate selectively using one of a greater bandwidth and a lesser bandwidth;
a plurality of wireless transceivers (non-WLAN transceivers), whose wireless communication is incompatible with the WLAN; and
a first wireless device comprising one of the plurality of WLAN transceivers and one of the plurality of non-WLAN transceivers;
wherein the non-WLAN transceiver in the first wireless device is configured to communicate with the WLAN transceiver in the first wireless device, and to request the WLAN transceiver in the first wireless device operate using the lesser bandwidth.

15. The wireless system of claim 14, wherein the WLAN transceiver in the first wireless device receives a request from the non-WLAN transceiver in the first wireless device to operate using the lesser bandwidth, the WLAN transceiver in the first wireless device notifies the plurality of WLAN transceivers in the wireless system of the request, and the plurality of WLAN transceivers operate using the lesser bandwidth based on the request.

16. The wireless system of claim 14, further comprising:
a second wireless device, the second wireless device comprises one of the plurality of non-WLAN transceivers;
wherein the non-WLAN transceiver in the second wireless device is not configured to communicate with any of the plurality of WLAN transceivers in the wireless system;
wherein the non-WLAN transceiver in the second wireless device transmits a message to the non-WLAN transceiver in the first wireless device, the message includes a request that the plurality of WLAN transceivers operate using the lesser bandwidth, and the non-WLAN transceiver in the first wireless device requests that the WLAN transceiver in the first wireless device operate using the lesser bandwidth based on the message.

17. The wireless system of claim 14, wherein the non-WLAN transceiver in the first wireless device intermittently exits a low power mode to listen for a message requesting that the plurality of WLAN transceivers operate using the lesser bandwidth, the message is transmitted by a different one of the plurality of non-WLAN transceivers.

18. The wireless system of claim 14, wherein the non-WLAN transceiver in the first wireless device wirelessly transmits a message indicating that the non-WLAN transceiver is co-located with the WLAN transceiver in the first wireless device, and indicating that the non-WLAN transceiver in the first wireless device is configured to request that the WLAN transceiver in the first wireless device operate using the lesser bandwidth.

19. The wireless system of claim 14, wherein the WLAN transceiver in the first wireless device intermittently exits a low power state to detect operation of a different one of the plurality of WLAN transceivers using the greater bandwidth, and if operation of a different one of the plurality of WLAN transceivers using the greater bandwidth is detected, the WLAN transceiver in the first wireless device notifies the plurality of WLAN transmitters in a wireless system of a request to operate using the lesser bandwidth.

20. The wireless system of claim 14, wherein the plurality of WLAN transceivers is IEEE 802.11n transceivers, the greater bandwidth is 40 megahertz and the lesser bandwidth is 20 megahertz.
